(19) United States
(12) Patent Application Publication
(10) Pub. No.: US 2026/0204857 A1
(43) Pub. Date: Jul. 16, 2026

(54) EMBEDDED CONDUCTIVE DEVICE

(71) Applicant: WUJIANG TIANLONG ELECTRONIC MACHINERY EQUINPMENT CO., LTD., Suzhou (CN)

(72) Inventors: Junhua WANG, Suzhou (CN); Jiacheng QIAN, Suzhou (CN); Zhenjie YANG, Suzhou (CN)

(21) Appl. No.: 19/559,113

(22) Filed: Mar. 6, 2026

Related U.S. Application Data
(63) Continuation of application No. PCT/CN2024/072729, filed on Jan. 17, 2024.

(30) Foreign Application Priority Data
Dec. 28, 2023 (CN) 202311842343.8

(51) Int. Cl. H01R 39/08; H01R 39/14; H01R 39/20; H01R 39/26; H02K 13/00

(52) U.S. Cl. CPC H01R 39/08; H01R 39/14; H01R 39/20; H01R 39/26; H02K 13/003

(57) ABSTRACT

The present disclosure provides an embedded conductive device, belonging to the technical field of conductive devices for motors. the embedded conductive device comprising an annular outer cover, a bundled-brush conductive ring, and a first locking ring, at least two bundled-brush conductive rings are sequentially arranged on the annular outer cover, the first locking ring presses each bundled-brush conductive ring onto the annular outer cover, conductive pads are provided between adjacent bundled-brush conductive rings and between the first locking ring and the bundled-brush conductive ring adjacent to the first locking ring; each bundled-brush conductive ring is fixedly provided with a soft conductive bundled-brush group and/or a hard conductive bundled-brush group that are in interference contact with the motor shaft, and all of the bundled-brush conductive rings cannot simultaneously be provided with only the soft conductive bundled-brush group or the hard conductive bundled-brush group. The embedded conductive device provided by the present disclosure can improve the contact effect with the motor shaft and avoid electro-corrosion of the motor bearing.

### TECHNICAL FIELD

The present disclosure relates to the technical field of conductive devices for motors, and in particular to an embedded conductive device.

### BACKGROUND

The shaft voltage of a variable frequency motor is generated by the frequency converter drive. The current output by the frequency converter induces a voltage on the motor shaft due to the action of high-frequency switching. As static charge accumulates, once the induced voltage on the motor shaft reaches a level sufficient to break down the oil film between the bearing balls, it will discharge through the circuit with the least resistance, causing electro-corrosion pits between the bearing balls and the track. Simultaneously, the high-speed rolling of the bearings will quickly fill the entire bearing track with these pits. Therefore, it is necessary to conduct the electrical charge on the motor shaft in a timely manner to improve the bearing's service life. However, existing motor shaft conductive rings use conductive fiber bundles of the same hardness for their conductive brushes. After prolonged use, these brushes are prone to wear, resulting in a reduced contact area with the motor shaft, preventing the timely discharge of electrical charge from the motor shaft.

### SUMMARY

The purpose of the present disclosure is to provide an embedded conductive device to solve the problems existing in the prior art, improve the contact effect with the motor shaft, and avoid electro-corrosion of the motor bearing.

To achieve the above objectives, the present disclosure provides the following solution:

The present disclosure provides an embedded conductive device, comprising an annular outer cover, a bundled-brush conductive ring, and a first locking ring, at least two bundled-brush conductive rings are sequentially arranged on the annular outer cover, the first locking ring presses each bundled-brush conductive ring onto the annular outer cover, conductive pads are provided between adjacent bundled-brush conductive rings and between the first locking ring and the bundled-brush conductive ring adjacent to the first locking ring; each bundled-brush conductive ring is fixedly provided with a soft conductive bundled-brush group and/or a hard conductive bundled-brush group that are in interference contact with the motor shaft, and all of the bundled-brush conductive rings cannot simultaneously be provided with only the soft conductive bundled-brush group or the hard conductive bundled-brush group.

Optionally, a first sealing ring is provided between the first locking ring and the conductive pad adjacent to the first locking ring, and a second sealing ring and a second locking ring are sequentially provided on the side of the annular outer cover faces away from the bundled-brush conductive ring, and the second locking ring presses the second sealing ring onto the annular outer cover; both the first sealing ring and the second sealing ring are interference-fitted with the motor shaft, and each of the bundled-brush conductive ring is disposed between the first sealing ring and the second sealing ring.

Optionally, the annular outer cover is provided with fixing holes for fixed installation with the motor housing, the annular outer cover is fixed to the motor housing by bolts passing through the fixing holes.

Optionally, the interference fit amounts between the soft conductive bundled-brush group and the hard conductive bundled-brush group and the motor shaft is the same.

Optionally, the soft conductive bundled-brush group includes various soft conductive bundled brushes of different lengths, and the hard conductive bundled-brush group includes various hard conductive bundled brushes of different lengths. The interference fit amounts between each soft conductive bundled brush and each hard conductive bundled brush and the motor shaft is the same.

Optionally, two bundled-brush conductive rings are sequentially arranged on the annular outer cover, namely a first bundled-brush conductive ring and a second bundled-brush conductive ring; the first bundled-brush conductive ring has a plurality of soft conductive bundled brushes evenly arranged circumferentially, and the second bundled-brush conductive ring has a plurality of hard conductive bundled brushes evenly arranged circumferentially.

Optionally, soft conductive bundled brushes of the same length are continuously arranged on the first bundled-brush conductive ring, and hard conductive bundled brushes of the same length are continuously arranged on the second bundled-brush conductive ring.

Optionally, the first bundled-brush conductive ring has a first fixing groove for fixing each of the soft conductive bundled brushes, and the second bundled-brush conductive ring has a second fixing groove for fixing each of the hard conductive bundled brushes.

Optionally, the soft conductive bundled brushes are obtained by compressing a steel tube after inserting two layers of 24K fine carbon fiber inside the steel tube; the hard conductive bundled brushes are obtained by compressing a steel tube after inserting two layers of 24K hard carbon fiber inside the steel tube.

Optionally, the annular outer cover, each of the bundled-brush conductive rings, and each of the conductive pads are connected and fixed by multiple conductive sleeves, each of the annular outer cover, each of the bundled-brush conductive rings, and each of the conductive pads has multiple locking holes evenly distributed circumferentially for the conductive sleeves to pass through.

Optionally, the conductive sleeves are copper sleeves.

Compared with the prior art, the present disclosure achieves the following technical effects:

The embedded conductive device provided by the present disclosure combines a soft conductive bundled-brush group and a hard conductive bundled-brush group, the hard conductive bundled brush can provide good conductivity and oil removal ability in the short term, but it wears out quickly, the soft conductive bundled brush is wear-resistant but is easily blocked by oil, resulting in unstable conductivity. Therefore, the combination of the two can meet the long-term good conductivity effect, thereby improving the contact effect with the motor shaft and avoiding electro-corrosion of the motor bearing.

### BRIEF DESCRIPTION OF THE DRAWINGS

To more clearly illustrate the technical solutions in the embodiments of the present disclosure or the prior art, the drawings used in the embodiments will be briefly introduced below. Obviously, the drawings described below are only some embodiments of the present disclosure. For those skilled in the art, other drawings can be obtained based on these drawings without creative effort.

FIG. 1 shows an exploded structural diagram of the embedded conductive device provided by the present disclosure.

FIG. 2 shows a partial sectional view of the embedded conductive device provided by the present disclosure.

FIG. 3 shows a front view of the annular outer cover in the present disclosure.

FIG. 4 shows a cross-sectional view along line A-A of the annular outer cover in FIG. 3.

FIG. 5 shows a partially enlarged schematic diagram of part B in FIG. 4.

FIG. 6 shows a front view of the first bundled-brush conductive ring in the present disclosure.

FIG. 7 shows a front view of the second bundled-brush conductive ring in the present disclosure.

FIG. 8 shows a front view of the conductive pad in the present disclosure.

Reference numerals: embedded conductive device 100; annular outer cover 1; first locking ring 2; conductive pad 3; fixing holes 4; first sealing ring 5; second sealing ring 6; second locking ring 7; first bundled-brush conductive ring 8; second bundled-brush conductive ring 9; soft conductive bundled brush 10; hard conductive bundled brush 11; first fixing groove 12; first fixing groove 13; locking hole 14.

### DETAILED DESCRIPTION OF THE EMBODIMENTS

The technical solutions of the embodiments of the present disclosure will be clearly and completely described below with reference to the accompanying drawings. Obviously, the described embodiments are only a part of the embodiments of the present disclosure, and not all of them. Based on the embodiments of the present disclosure, all other embodiments obtained by those skilled in the art without creative effort are within the scope of protection of the present disclosure.

The purpose of the present disclosure is to provide an embedded conductive device to solve the problems existing in the prior art, which can improve the contact effect with the motor shaft and avoid electro-corrosion of the motor bearing.

To make the above-mentioned objectives, features, and advantages of the present disclosure more apparent and understandable, the present disclosure will be further described in detail below with reference to the accompanying drawings and specific embodiments.

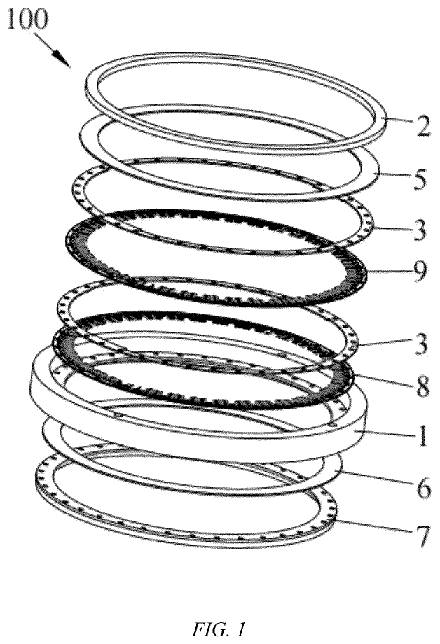

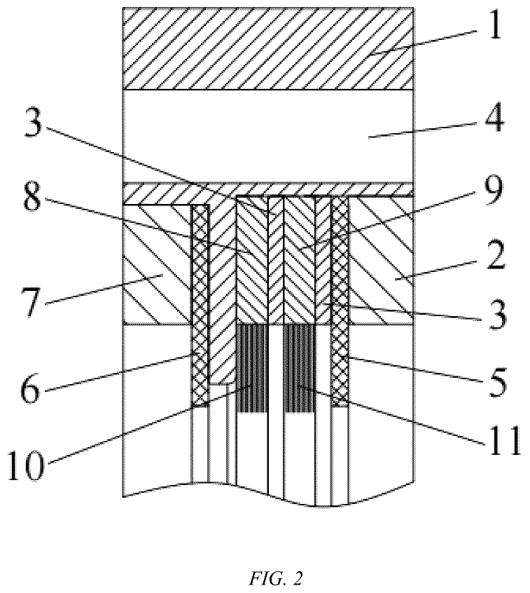

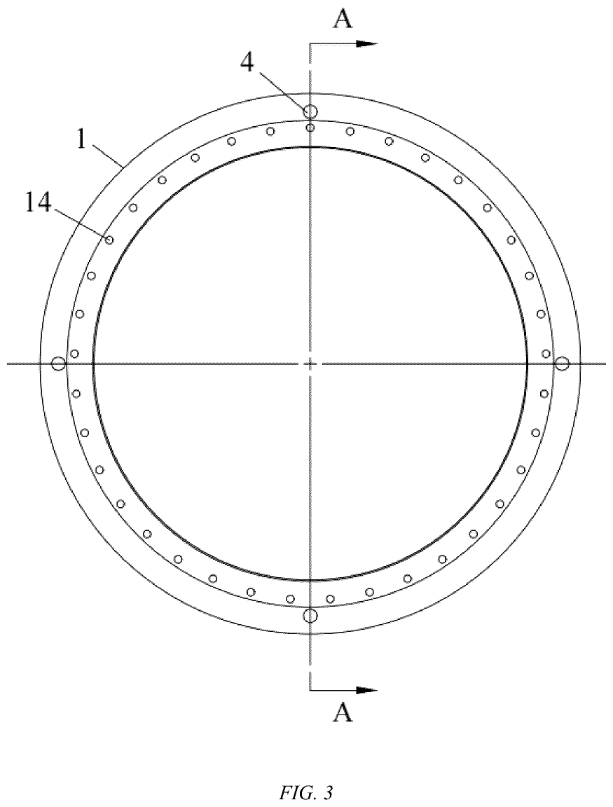

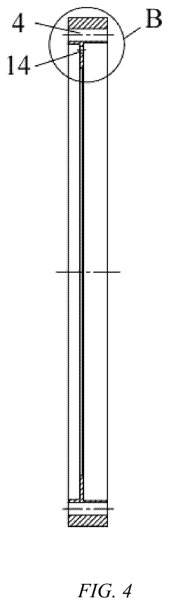

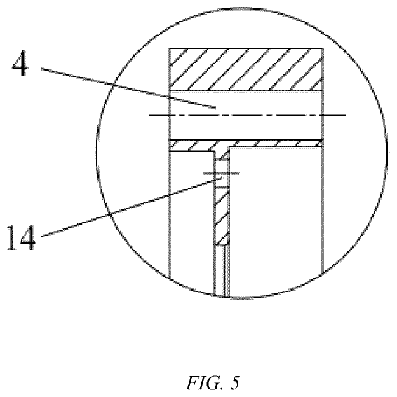

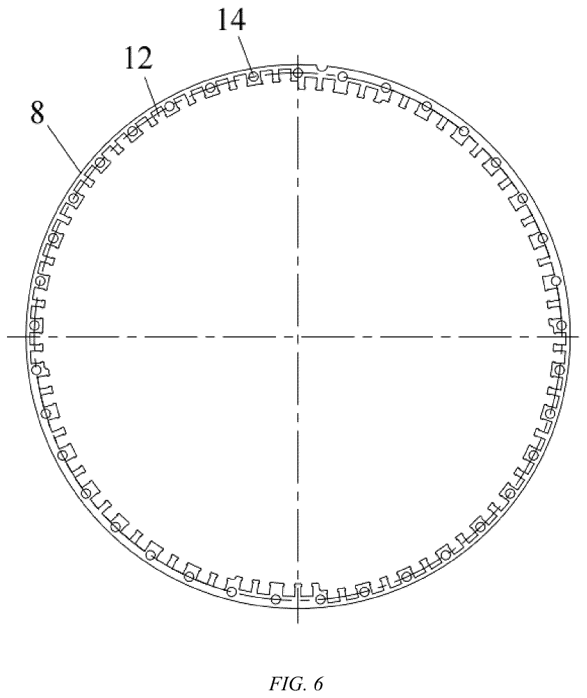

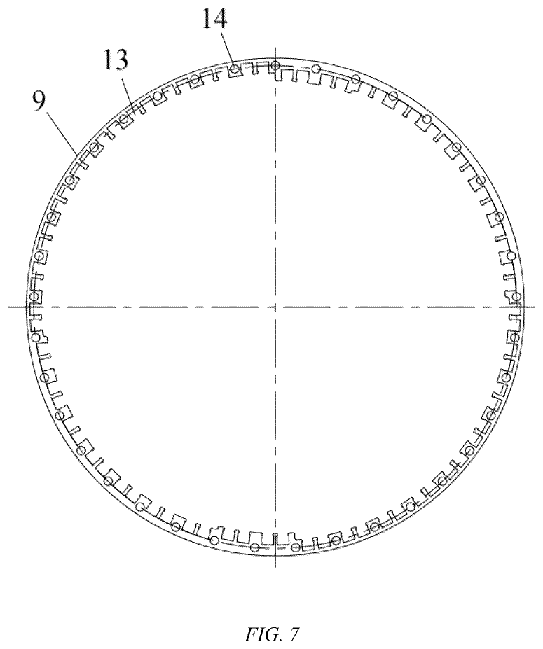

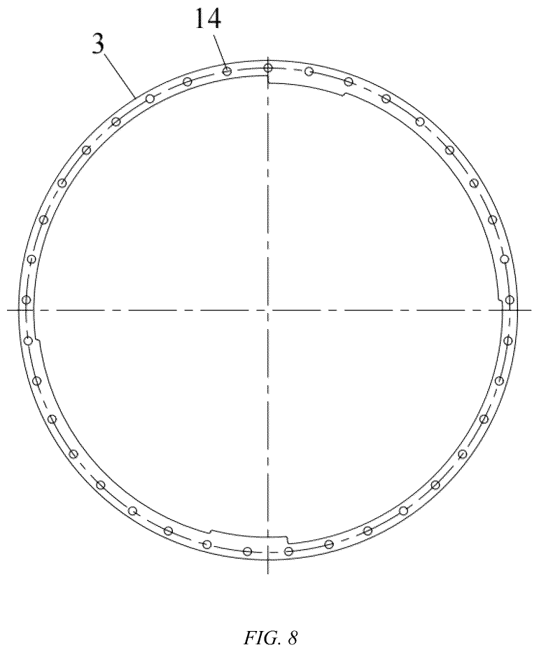

Referring to FIG. 1 to FIG. 8, this embodiment provides an embedded conductive device 100, comprising an annular outer cover 1, a bundled-brush conductive ring, and a first locking ring 2, at least two bundled-brush conductive rings are sequentially arranged on the annular outer cover 1, the first locking ring 2 presses each bundled-brush conductive ring onto the annular outer cover 1, conductive pads 3 are provided between adjacent bundled brush conductive rings and between the first locking ring 2 and the bundled-brush conductive ring adjacent to the first locking ring 2; each bundled-brush conductive ring is fixedly provided with a soft conductive bundled-brush group and/or a hard conductive bundled-brush group that are in interference contact with the motor shaft, and all of the bundled-brush conductive rings cannot simultaneously be provided with only the soft conductive bundled-brush group or the hard conductive bundled-brush group.

In this embodiment, a first sealing ring 5 is provided between the first locking ring 2 and the conductive pad 3 adjacent to the first locking ring 2, and a second sealing ring 6 and a second locking ring 7 are sequentially provided on the side of the annular outer cover 1 faces away from the bundled-brush conductive ring, and the second locking ring 7 presses the second sealing ring 6 onto the annular outer cover 1; both the first sealing ring 5 and the second sealing ring 6 are interference-fitted with the motor shaft, and each of the bundled-brush conductive ring is disposed between the first sealing ring 5 and the second sealing ring 6. The first sealing ring 5 and the second sealing ring 6 enclose the conductive brushes on each bundled-brush conductive ring, which improves the equipment's protection level and prevents the carbon fiber powder from contaminating the equipment's grease after the conductive brushes wear down. It also protects the conductive brushes from grease immersion, and the worn carbon fiber powder remains within the conductive sealed cavity, still participating in the conductive process during operation, thus improving the conductivity and lifespan of the conductive rings. The first locking ring 2 and the second locking ring 7 are interference-fitted to the annular outer cover 1.

In this embodiment, the annular outer cover 1 is provided with fixing holes 4 for fixed installation with the motor housing, the annular outer cover is fixed to the motor housing by bolts passing through the fixing holes 4. In other embodiments, the annular outer cover 1 can also be installed with the motor housing using an interference fit connection.

In this embodiment, two bundled-brush conductive rings are sequentially arranged on the annular outer cover 1, namely a first bundled-brush conductive ring 8 and a second bundled-brush conductive ring 9.

In this embodiment, the first bundled-brush conductive ring 8 and the second bundled-brush conductive ring 9 have the same structure. A soft conductive bundled-brush group is arranged on the first bundled-brush conductive ring 8, while a hard conductive bundled-brush group is arranged on the second bundled-brush conductive ring 9. This device combines the soft conductive bundled-brush group and the hard conductive bundled-brush group. While hard conductive bundled brushes provide good conductivity and oil removal capabilities in the short term, they wear out quickly. Soft conductive bundled brushes are wear-resistant but are easily blocked by oil, leading to unstable conductivity. Therefore, combining the two ensures long-term good conductivity, thereby improving the contact with the motor shaft and preventing electro-corrosion of the motor bearings. In other embodiments, a hard conductive bundled-brush group can be provided on the first bundled-brush conductive ring 8, and a soft conductive bundled-brush group can be provided on the second bundled-brush conductive ring 9; or a soft conductive bundled-brush group and a hard conductive bundled-brush group can be provided on the first bundled-brush conductive ring 8, and a soft conductive bundled-brush group or a hard conductive bundled-brush group can be provided on the second bundled-brush conductive ring 9; or a soft conductive bundled-brush group or a hard conductive bundled-brush group can be provided on the first bundled-brush conductive ring 8, and a soft conductive bundled-brush group and a hard conductive bundled-brush group can be provided on the second bundled-brush conductive ring 9; or both the first bundled-brush conductive ring 8 and the second bundled-brush conductive ring 9 can be provided with a soft conductive bundled-brush group and a hard conductive bundled-brush group.

In this embodiment, the interference fit amounts between the soft conductive bundled-brush group and the hard conductive bundled-brush group and the motor shaft is the same. In the other embodiment, the interference fit amounts between the soft conductive bundled-brush group and the hard conductive bundled-brush group and the motor shaft can also be different.

In this embodiment, the soft conductive bundled-brush group includes various soft conductive bundled brushes 10 of different lengths, and the hard conductive bundled-brush group includes various hard conductive bundled brushes 11 of different lengths. The interference fit amounts between each soft conductive bundled brush 10 and each hard conductive bundled brush 11 and the motor shaft is the same. Specifically, the soft conductive bundled-brush group includes three lengths of soft conductive bundled brush 10, namely 11 mm, 9.5 mm and 8 mm; the hard conductive bundled-brush group includes three lengths of hard conductive bundled brush 11, namely 11 mm, 9.5 mm and 8 mm.

In this embodiment, the first bundled-brush conductive ring 8 has a plurality of soft conductive bundled brushes 10 evenly arranged circumferentially, and the second bundled-brush conductive ring 9 has a plurality of hard conductive bundled brushes 11 evenly arranged circumferentially. Among them, the soft conductive bundled brush 10 corresponds one-to-one with the hard conductive bundled brush 11, and the number of soft conductive bundled brushes 10 and hard conductive bundled brushes 11 of the same length is equal and corresponds one-to-one.

In this embodiment, soft conductive bundled brushes 10 of the same length are continuously arranged on the first bundled-brush conductive ring 8, and hard conductive bundled brushes 11 of the same length are continuously arranged on the second bundled-brush conductive ring 9. This facilitates the fabrication of the first bundled-brush conductive ring 8 and the second bundled-brush conductive ring 9, and facilitates the installation of each soft conductive bundled brush 10 and hard conductive bundled brush 11.

In this embodiment, the first bundled-brush conductive ring 8 has a first fixing groove 12 for fixing each of the soft conductive bundled brushes 10, and the second bundled-brush conductive ring 9 has a second fixing groove 13 for fixing each of the hard conductive bundled brushes 11. Specifically, the first bundled-brush conductive ring 8 is fixed with three different lengths of soft conductive bundled brushes 10, with lengths of 11 mm, 9.5 mm, and 8 mm respectively; the second bundled-brush conductive ring 9 is fixed with three different lengths of hard conductive bundled brushes 11, with lengths of 11 mm, 9.5 mm, and 8 mm respectively. Multiple 11 mm soft conductive bundled brushes 10 are installed in the first fixing groove 12 with an inner diameter of φ186 on the first bundled-brush conductive ring 8, multiple 9.5 mm soft conductive bundled brushes 10 are installed in the first fixing groove 12 with an inner diameter of φ183 on the first bundled-brush conductive ring 8, and multiple 8 mm soft conductive bundled brushes 10 are installed in the first fixing groove 12 with an inner diameter of φ180 on the first bundled-brush conductive ring 8, thereby ensuring that the interference fit amounts between the three types of soft conductive bundled brushes 10 and the motor shaft is the same; multiple 11 mm hard conductive bundled brushes 11 are installed in the second fixing groove 13 with an inner diameter of φ186 on the second bundled-brush conductive ring 9, multiple 9.5 mm hard conductive bundled brushes 11 are installed in the second fixing groove 13 with an inner diameter of φ183 on the second bundled-brush conductive ring 9, multiple 8 mm hard conductive bundled brushes 11 are installed in the second fixing groove 13 with an inner diameter of φ180 on the second bundled-brush conductive ring 9. This ensures that the interference fit amounts between the three types of hard conductive bundled brushes 11 and the motor shaft is the same, and that the interference fit amounts between the three types of soft conductive bundled brushes 10 and the motor shaft is the same.

In this embodiment, the soft conductive bundled brushes 10 are obtained by compressing a steel tube after inserting two layers of 24K fine carbon fiber inside the steel tube; the hard conductive bundled brushes 11 are obtained by compressing a steel tube after inserting two layers of 24K hard carbon fiber inside the steel tube.

In this embodiment, the annular outer cover 1, each bundled-brush conductive ring (first bundled-brush conductive ring 8 and second bundled-brush conductive ring 9), and each conductive pad 3 are connected and fixed by multiple conductive sleeves, each of the annular outer cover 1, each of the bundled-brush conductive rings, and each of the conductive pads 3 has multiple locking holes 14 evenly distributed circumferentially for the conductive sleeves to pass through. The interconnection of multiple conductive sleeves makes the connection more secure. In use, the electrical current on the motor shaft can be transferred to the annular outer cover 1 through the conductive sleeves, and then the electrical current can be conducted to the grounded motor housing through the annular outer cover 1.

In this embodiment, the conductive sleeves are copper sleeves. Using copper sleeves ensures stable performance, low resistance, and facilitates electrical current transmission.

Specific examples have been used to illustrate the principles and implementation methods of this present disclosure. The descriptions of the above embodiments are only for the purpose of helping to understand the method and core ideas of this present disclosure. Furthermore, those skilled in the art will recognize that, based on the ideas of this present disclosure, there will be changes in the specific implementation methods and application scope. Therefore, the content of this specification should not be construed as a limitation of this present disclosure.

1. An embedded conductive device, wherein the embedded conductive device comprising an annular outer cover, a bundled-brush conductive ring, and a first locking ring, at least two bundled-brush conductive rings are sequentially arranged on the annular outer cover, the first locking ring presses each bundled-brush conductive ring onto the annular outer cover, conductive pads are provided between adjacent bundled-brush conductive rings and between the first locking ring and the bundled-brush conductive ring adjacent to the first locking ring; each bundled-brush conductive ring is fixedly provided with a soft conductive bundled-brush group and/or a hard conductive bundled-brush group that are in interference contact with the motor shaft, and all of the bundled-brush conductive rings cannot simultaneously be provided with only the soft conductive bundled-brush group or the hard conductive bundled-brush group.

2. The embedded conductive device according to claim 1, wherein a first sealing ring is provided between the first locking ring and the conductive pad adjacent to the first locking ring, and a second sealing ring and a second locking ring are sequentially provided on the side of the annular outer cover faces away from the bundled-brush conductive ring, and the second locking ring presses the second sealing ring onto the annular outer cover; both the first sealing ring and the second sealing ring are interference-fitted with the motor shaft, and each of the bundled brush conductive ring is disposed between the first sealing ring and the second sealing ring.

3. The embedded conductive device according to claim 1, wherein the annular outer cover is provided with fixing holes for fixed installation with the motor housing, the annular outer cover is fixed to the motor housing by bolts passing through the fixing holes.

4. The embedded conductive device according to claim 1, wherein the interference fit amounts between the soft conductive bundled-brush group and the hard conductive bundled-brush group and the motor shaft is the same.

5. The embedded conductive device according to claim 1, wherein the soft conductive bundled-brush group includes various soft conductive bundled brushes of different lengths, and the hard conductive bundled-brush group includes various hard conductive bundled brushes of different lengths. The interference fit amounts between each soft conductive bundled brush and each hard conductive bundled brush and the motor shaft is the same.

6. The embedded conductive device according to claim 5, wherein two bundled-brush conductive rings are sequentially arranged on the annular outer cover, namely a first bundled-brush conductive ring and a second bundled-brush conductive ring; the first bundled-brush conductive ring has a plurality of soft conductive bundled brushes evenly arranged circumferentially, and the second bundled-brush conductive ring has a plurality of hard conductive bundled brushes evenly arranged circumferentially.

7. The embedded conductive device according to claim 6, wherein soft conductive bundled brushes of the same length are continuously arranged on the first bundled-brush conductive ring, and hard conductive bundled brushes of the same length are continuously arranged on the second bundled-brush conductive ring.

8. The embedded conductive device according to claim 6, wherein the first bundled-brush conductive ring has a first fixing groove for fixing each of the soft conductive bundled brushes, and the second bundled-brush conductive ring has a second fixing groove for fixing each of the hard conductive bundled brushes.

9. The embedded conductive device according to claim 5, wherein the soft conductive bundled brushes are obtained by compressing a steel tube after inserting two layers of 24K fine carbon fiber inside the steel tube; the hard conductive bundled brushes are obtained by compressing a steel tube after inserting two layers of 24K hard carbon fiber inside the steel tube.

10. The embedded conductive device according to claim 2, wherein the annular outer cover, each of the bundled-brush conductive rings, and each of the conductive pads are connected and fixed by multiple conductive sleeves, each of the annular outer cover, each of the bundled-brush conductive rings, and each of the conductive pads has multiple locking holes evenly distributed circumferentially for the conductive sleeves to pass through.
